(19) United States
(12) Patent Application Publication
(10) Pub. No.: US 2026/0021439 A1
(43) Pub. Date: Jan. 22, 2026

(54) HAZARDOUS GAS DIRECT AIR CAPTURE SYSTEM WITH VERTICAL EXHAUST PLENUM

(71) Applicant: GE Infrastructure Technology LLC, Greenville, SC (US)

(72) Inventors: Ankita Pujahari, Jaipur (IN); Murali Shri Harikrishnan, Bangalore (IN); Sagar Deshmukh, Bangalore (IN); Anindya Kanti De, Bangalore (IN); Szymon Pawel Modelski, Untersiggenthal (CH)

(21) Appl. No.: 18/983,511

(22) Filed: Dec. 17, 2024

Related U.S. Application Data
(63) Continuation-in-part of application No. 18/777,903, filed on Jul. 19, 2024.

(51) Int. Cl. B01D 53/04; G10K 11/16; G10K 11/172

(52) U.S. Cl. CPC B01D 53/0446; G10K 11/161; G10K 11/172; B01D 2257/504; B01D 2258/06

(57) ABSTRACT

A direct air capture (DAC) module includes a frame enclosing at least one level of hazardous gas capture contactors. A first air mover is configured to draw air into an inlet side of the frame and over the contactors to remove hazardous gas from the air, producing cleaned air from an outlet side of the frame. The DAC module also includes a vertical exhaust plenum fluidly coupled to the outlet side of the frame to direct the clean air exiting the outlet side of the frame away from the frame to reduce re-entry of the clean air into the inlet side of the frame. A DAC system includes set(s) of DAC modules.

### CONTINUATION INFORMATION

This application is a continuation-in-part application of co-pending U.S. patent application Ser. No. 18/777,903, filed Jul. 19, 2024, the entire contents of which are incorporated by reference herein.

### TECHNICAL FIELD

The disclosure relates generally to hazardous gas direct air capture systems. More specifically, the disclosure relates to a hazardous direct air capture system having a vertical exhaust plenum to reduce clean air recirculation and improve efficiency.

### BACKGROUND

Hazardous gas direct air capture uses modules to capture a hazardous gas, such as carbon dioxide (CO₂), from air. The process is also known as direct air capture (DAC). DAC modules typically include a mechanism to draw air into an inlet side of the module and over hazardous gas absorbing surfaces therein. The ‘clean air’ depleted of the hazardous gas exits the DAC modules from an opposing outlet side. DAC modules in a DAC system are typically arranged in an angular or staggered fashion. Preventing re-entry or recirculation of clean air from the outlet side to the inlet side of the DAC module(s) presents a challenge to efficient operation of DAC modules and systems. The re-entry of air reduces the hazardous gas capture efficiency of the DAC module or system by reducing the amount of hazardous gas captured per unit time and/or per system. The re-entry challenge may lead to the need for more DAC modules in a particular system which disadvantageously increases the footprint of the system.

### BRIEF DESCRIPTION

All aspects, examples and features mentioned below can be combined in any technically possible way.

An aspect of the disclosure provides a direct air capture (DAC) module, comprising: a frame enclosing at least one level, each level including a plurality of hazardous gas capture contactors; a first air mover configured to draw air into an inlet side of the frame and over the plurality of hazardous gas capture contactors to remove hazardous gas from the air, producing cleaned air from an outlet side of the frame; and a vertical exhaust plenum fluidly coupled to the outlet side of the frame, the vertical exhaust plenum in fluid communication with the outlet side of the frame and configured to direct the clean air exiting the outlet side of the frame away from the frame to reduce re-entry of the clean air into the inlet side of the frame.

Another aspect of the disclosure includes any of the preceding aspects, and the vertical exhaust plenum further includes a vertical passage and at least one side passage in fluid communication with the outlet side of the frame and the vertical passage.

Another aspect of the disclosure includes any of the preceding aspects, and the first air mover is positioned in the vertical passage of the vertical exhaust plenum.

Another aspect of the disclosure includes any of the preceding aspects, and the at least one level includes a plurality of levels, each respective level including the plurality of hazardous gas capture contactors and a second air mover configured to draw air into the inlet side of the frame at the respective level and over the plurality of hazardous gas capture contactors therein, and wherein the vertical exhaust plenum includes a vertical passage and a plurality of side passages, each side passage in fluid communication with a respective level at the outlet side of the frame.

Another aspect of the disclosure includes any of the preceding aspects, and the at least one level includes a plurality of levels, each respective level including the plurality of hazardous gas capture contactors and a respective first air mover configured to draw air into the inlet side of the frame at the respective level and over the plurality of hazardous gas capture contactors therein, and wherein the vertical exhaust plenum includes a plurality of side passages, each side passage in fluid communication with of a respective level at the outlet side of the frame.

Another aspect of the disclosure includes any of the preceding aspects, and the vertical exhaust plenum includes a noise-abatement system.

Another aspect of the disclosure includes any of the preceding aspects, and the noise-abate system includes a noise-abatement layer along at least a portion of an interior surface of the vertical exhaust plenum.

Another aspect of the disclosure includes any of the preceding aspects, and the noise-abate system includes a resonator in fluid communication with an interior of the vertical exhaust plenum.

Another aspect of the disclosure includes any of the preceding aspects, and the noise-abate system includes a set of louvers at a terminal end of the vertical exhaust plenum.

Another aspect of the disclosure includes a direct air capture (DAC) system, comprising: at least one DAC module set, each DAC module set including: a first direct air capture (DAC) module; a second DAC module adjacent the first DAC module, wherein each DAC module includes a frame including at least one level, each level including a plurality of hazardous gas capture contactors; at least one first air mover configured to draw air into an inlet side of the frame and over the plurality of hazardous gas capture contactors to remove hazardous gas from the air, producing cleaned air exiting an outlet side of the frame; and a vertical exhaust plenum mounted to each of the first and second DAC modules, each vertical exhaust plenum in fluid communication with the outlet side of the frame of a respective one of the first and second DAC modules and configured to direct the clean air exiting the outlet sides of the frames away from the frames to reduce re-entry of the clean air into the inlet sides of the frames.

Another aspect of the disclosure includes any of the preceding aspects, and each vertical exhaust plenum includes a vertical passage and a side passage in fluid communication with each respective level at the outlet side of the frames of the respective one of the first and second DAC modules.

Another aspect of the disclosure includes any of the preceding aspects, and at least one of the vertical exhaust plenums includes a noise-abatement system including at least one of: a noise-abatement layer along at least a portion of an interior surface of the vertical exhaust plenum, a resonator in fluid communication with an interior of the vertical exhaust plenum, and a set of louvers at a terminal end of the vertical exhaust plenum.

Another aspect of the disclosure includes any of the preceding aspects, and the at least one DAC module set includes at least two DAC module sets arranged in parallel to be substantially parallel to a predominate wind direction in a location of the at least two DAC module sets.

Another aspect of the disclosure includes any of the preceding aspects, and at least one of the vertical exhaust plenums includes at least one second air mover having a flow direction away from the frame to reduce re-entry of the clean air into the inlet side of the frame.

Another aspect of the disclosure includes any of the preceding aspects, and each vertical exhaust plenum has a terminal end vertically above an upper end of the frame of the respective one of the first and second DAC modules.

Another aspect of the disclosure includes a direct air capture (DAC) system, comprising: at least one DAC module set, each DAC module set including: a first direct air capture (DAC) module; a second DAC module adjacent the first DAC module, wherein each DAC module includes a frame including at least one level, each level including an inlet side, a plurality of hazardous gas capture contactors and an outlet side; at least one first air mover configured to draw air into the inlet side of the frame and over the plurality of hazardous gas capture contactors to remove hazardous gas from the air, producing cleaned air exiting the outlet side of the frame; and a vertical exhaust plenum mounted between the first and second DAC modules, the vertical exhaust plenum in fluid communication with the outlet side of the frames of the first and second DAC modules and configured to direct the clean air exiting the outlet sides of the frames away from the frames to reduce re-entry of the clean air into the inlet sides of the frames, wherein the vertical exhaust plenum includes a vertical passage and a side passage in fluid communication with the outlet sides of the frames of the first and second DAC modules.

Another aspect of the disclosure includes any of the preceding aspects, and the at least one first air mover is positioned in the vertical passage of the vertical exhaust plenum.

Another aspect of the disclosure includes any of the preceding aspects, and the vertical exhaust plenum includes a single vertical passage in fluid communication with a side passage in fluid communication with the outlet side of the first DAC module and a side passage in fluid communication with the outlet side of the second DAC module.

Another aspect of the disclosure includes any of the preceding aspects, and the vertical exhaust plenum includes a noise-abatement system including at least one of: a noise-abatement layer along at least a portion of an interior surface of the vertical exhaust plenum, a resonator in fluid communication with an interior of the vertical exhaust plenum, and a set of louvers at a terminal end of the vertical exhaust plenum.

Another aspect of the disclosure includes any of the preceding aspects, and the vertical exhaust plenum has a terminal end vertically above an upper end of each of the frame of the first and second DAC modules.

Two or more aspects described in this disclosure, including those described in this summary section, may be combined to form implementations not specifically described herein. That is, all embodiments described herein can be combined with each other.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a perspective view of a prior art direct air capture (DAC) module;

FIG. 2 shows a top-down view of a prior art arrangement of DAC modules;

FIG. 3 shows a top-down view of another prior art arrangement of DAC modules;

FIG. 4 shows a side view of a direct air capture (DAC) module according to embodiments of the disclosure;

FIG. 5 shows an exploded outlet side, perspective view of a DAC module according to embodiments of the disclosure;

FIG. 6 shows an inlet side perspective view of the DAC module of FIG. 5;

FIG. 7 shows an exploded outlet side, perspective view of a DAC module according to other embodiments of the disclosure;

FIG. 8 shows a side view of a direct air capture (DAC) module according to other embodiments of the disclosure;

FIG. 9 shows an inlet side perspective view of a vertical exhaust plenum according to an alternative embodiment of the disclosure;

FIG. 10 shows a cross-sectional view of a noise-abatement layer on an interior surface of a wall of a vertical exhaust plenum according to embodiments of the disclosure;

FIG. 11 shows an inlet side perspective view of a vertical exhaust plenum according to another embodiment of the disclosure;

FIG. 12 shows an inlet side perspective view of a vertical exhaust plenum according to yet another embodiment of the disclosure;

FIG. 13 shows a perspective view of DAC module system according to an another embodiment of the disclosure;

FIG. 14 shows a side view of a DAC module system according to other embodiments of the disclosure;

FIG. 15 shows a perspective view of the DAC module system of FIG. 14;

FIG. 16 shows a top-down view of a set of a plurality of DAC modules for a DAC system according to embodiments of the disclosure; and

FIG. 17 shows a top-down view of a DAC system including at least one set of a plurality of DAC modules according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current technology, it will become necessary to select certain terminology when referring to and describing relevant components within the illustrative application of a direct air capture system. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as air through a direct air capture module or, for example, the flow of air through direct air capture system including set(s) of hazardous gas direct air capture modules. The term “downstream” corresponds to the direction of flow of the fluid, and the term “upstream” refers to the direction opposite to the flow.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” an, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs or the feature is present and instances where the event does not occur or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

Embodiments of the disclosure include a hazardous gas direct air capture (DAC) module and a DAC system. The DAC module includes a frame enclosing at least one level of hazardous gas capture contactors. A first air mover is configured to draw air into an inlet side of the frame and over the contactors to remove hazardous gas from the air, producing cleaned air from an outlet side of the frame. The DAC module also includes a vertical exhaust plenum fluidly coupled to the outlet side of the frame to direct the clean air exiting the outlet side of the frame away from the frame to reduce re-entry of the clean air into the inlet side of the frame. A DAC system includes set(s) of DAC modules. The module and systems reduce clean air recirculation and are more efficient than conventional versions. The DAC modules with vertical exhaust plenum also reduce the footprint of DAC systems.

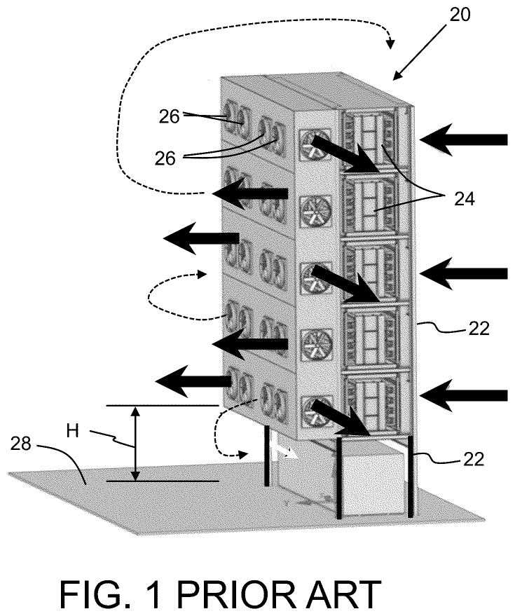

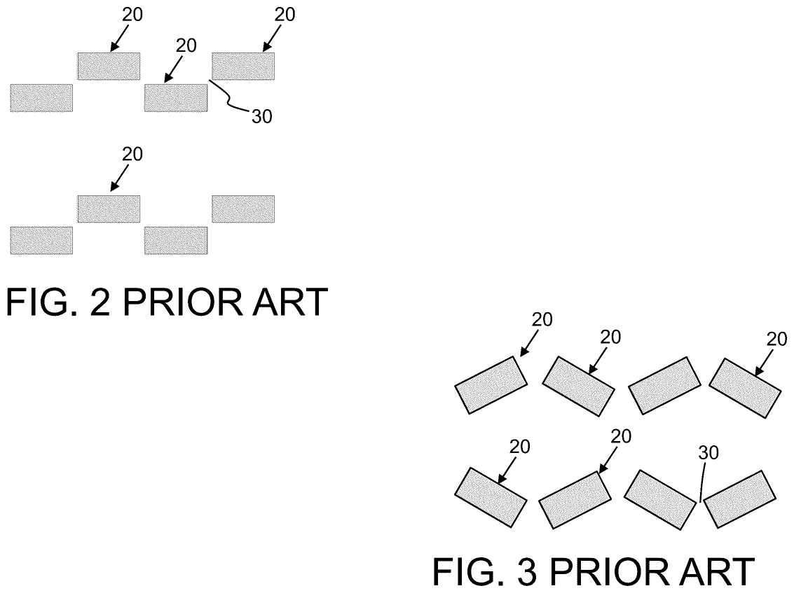

FIG. 1 shows a perspective view of a prior art direct air capture (DAC) module 20. The DAC module 20 includes a frame 22 including a plurality of hazardous gas capture contactors 24. A plurality of fans 26 pull air over contactors 24 to remove hazardous gas from an air flow (large black arrows). As shown in FIGS. 2 and 3, conventional DAC modules 20 are typically arranged in formations to draw in as much air as possible. FIG. 1 shows a variety of clean air flow paths (dashed arrows) that lead back to an inlet of DAC modules 20. As noted, re-entry or re-circulation of clean air into DAC modules 20 diminishes the efficiency of DAC modules 20 because a large amount of the air they inlet is already clean air, i.e., air that has already passed through one or more DAC modules 20. It has been discovered that the re-entry of the air is caused by the arrangements of DAC modules 20 and the movement of air over, under and around the sides of DAC modules 20 that allows the clean air to pass, possibly repeatedly, to the inlet side of DAC modules 20. For example, as shown in FIG. 1, DAC modules 20 have contactors 24 and fans 26 raised above surface 28, i.e., the ground or a foundation, within frame 22 by a height H so clean air can flow thereunder. As shown in FIGS. 2-3, DAC modules 20 have spaces 30 therebetween through which clean air can pass back to the inlet sides thereof. As shown in FIG. 1, clean air can also pass over DAC modules 20 and back to the inlet side thereof.

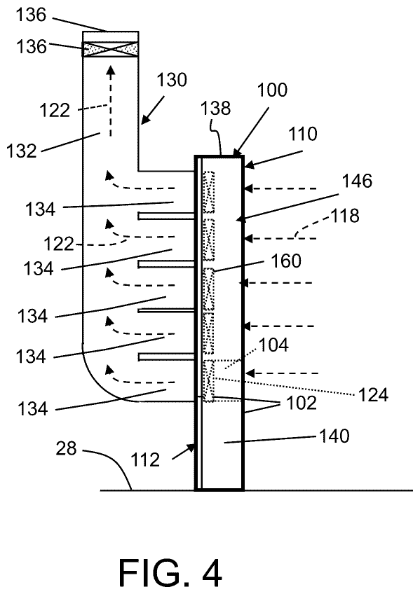

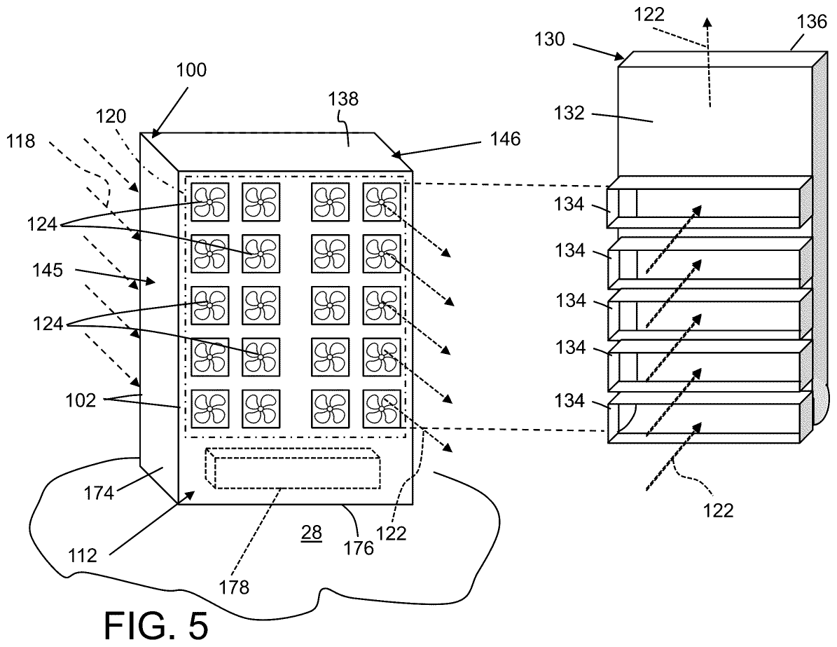

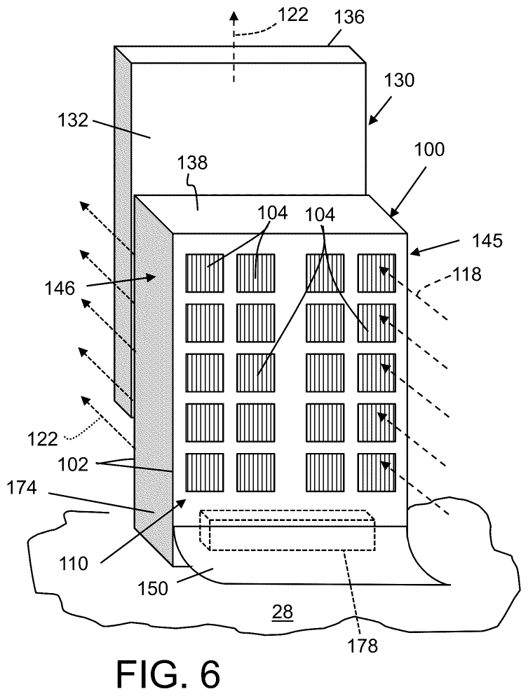

FIG. 4 shows a side view, FIG. 5 shows an exploded outlet side, perspective view and FIG. 6 shows an inlet side, perspective view of a direct air capture (DAC) module 100 according to embodiments of the disclosure. (Note, FIG. 5 shows DAC module 100 with a vertical exhaust plenum 130 according to embodiments of the disclosure, but with vertical exhaust plenum 130 disconnected and set to the side for illustration purposes). Referring to FIGS. 4-6, DAC module 100 includes a frame 102 enclosing a plurality of hazardous gas capture contactors 104 (FIG. 4 only). Frame 102 may include any now known or later developed form of structural framing elements, e.g., of metal(s), composite(s), etc., coupled to provide support to the rest of DAC modules on surface 28. Frame 102 may enclose and/or support hazardous gas capture contactors 104. Hazardous gas capture contactors 104 (hereafter “contactors 104”) may include any now known or later developed gas adsorption structure and materials configured to remove the desired hazardous gas. As used herein, “hazardous gas” may include any gas that is unwanted in the air. In one non-limiting example, contactors 104 may include parallel metal plates coated with a hazardous gas absorbing material. For carbon dioxide, the absorbing material may include but is not limited to: silica, metal oxides, zeolites, alumina, metal organic frameworks (MOFs), amine-based materials, polymers and/or carbon materials such as graphite, graphene, fullerene, activated carbon, hydrochar, carbon nanotubes and/or biochar. For purposes of description, DAC module 100 may be described as configured to remove carbon dioxide from air; however, it will be recognized that DAC modules 100 may be configured to remove other forms of contaminants from air such as but not limited to carbon monoxide (CO), nitrous oxide (NOx), sulfur oxide (SOx), chlorofluorocarbons (CFCs), particulates, and hydrocarbons. Contactors 104 may use alternative structure and/or absorbing material depending on the hazardous gas targeted for removal. As the structure and form of these alternatives are generally known, no further details are provided so the reader can focus on the salient points of the disclosure.

DAC module 100 and, more particularly, frame 102, includes an inlet side 110 through which dirty (i.e., unprocessed) air 118 (arrows) enters DAC module 100, and an outlet side 112 from which clean air 122 (arrows) exits DAC module 100. DAC module 100 also may optionally include an air mover 120 (FIG. 5) configured to draw dirty air 118 into inlet side 110 of frame 102 and over contactors 104 to remove hazardous gas from dirty air 118, producing cleaned air 122. As used herein, “clean air” 122 indicates air that has been processed by DAC module 100 to remove any contaminants for which DAC module 100 is configured to remove, e.g., hazardous gas such as carbon dioxide, and thus includes less of that contaminant than “dirty air” 118 entering DAC module 100. For context purposes only, in one non-limiting example, dirty air may include approximately 400 parts per million (ppm) carbon dioxide, and clean air 122 may include approximately 60 ppm carbon dioxide.

Where provided in frame 102 of DAC module 100, air mover 120 may include any now known or later developed system to move a gas stream, i.e., air. In the non-limiting example shown, air mover 120 may include a plurality of fans 124 spaced downstream of contactors 104 (FIG. 6, one schematically shown in FIG. 4). Fans 124 may include any now known or later developed industrial fan configured to move a gas stream and may be aimed in any desired manner to direct air flow. Note, DAC module 100 does not include fans 124 in sides 145, 146 of frame 102 as in prior art DAC module 20 (FIG. 1) to prevent directing clean air 122 upstream toward inlet side 110 and needlessly causing re-entry and recirculation of clean air 122.

DAC module 100 also includes a vertical exhaust plenum 130 fluidly coupled to outlet side 112 of frame 102. Vertical exhaust plenum 130 is in fluid communication with outlet side 112 of frame so it receives clean air 122 from one or more (typically all) levels of frame 102. “Level” as used herein indicates a horizontal row of contactors 104 and perhaps respective fans 124 where the latter is provided. The illustrative embodiments in FIGS. 4-6 shows DAC module 100 with five levels. While the drawings show five levels, it is emphasized that each DAC module 100 may include any number of levels, e.g., 1, 2, 3, 4 or more than 5.

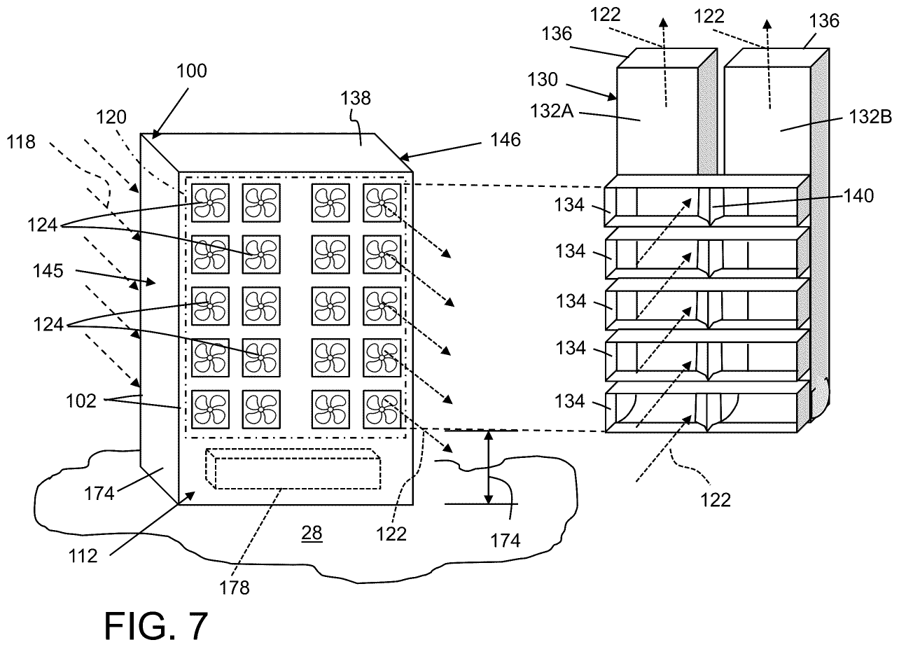

Vertical exhaust plenum 130 is configured to direct clean air 122 exiting outlet side 112 of frame 102 away from frame 102 to reduce re-entry of clean air 122 into inlet side 110 of frame 102. In certain embodiments, as shown in the drawings, vertical exhaust plenum 130 includes a vertical passage 132 and at least one side passage 134. Side passage(s) 134 are in fluid communication with outlet side 112 of frame 102, e.g., at one or more levels, and in fluid communication with vertical passage 132. While some levels may share a particular side passage 134, the drawings show each level having its own side passage 134. In FIGS. 4-6, vertical exhaust plenum 130 includes a single vertical passage 132; however, where levels of DAC module 100 are arranged in more than one column, more than one vertical passage 132 may be provided. For example, FIG. 7 shows an exploded inlet side, perspective view of DAC module 100 with vertical exhaust plenum 130 including two vertical passages 132A, 132B according to other embodiments of the disclosure. Each vertical passage 132A, 132B receives clean air 122 from a particular column of contactor(s) 104 (FIG. 6) and related fan(s) 124 (where latter provided).

Regardless of form, vertical exhaust plenum 130 has a terminal end 136 vertically above an upper end 138 of frame(s) 102 of DAC module(s) 100 to which it is operatively attached. More particularly, vertical passage(s) 132 of vertical exhaust plenum 130 has terminal end(s) 136 above upper end 138 of each frame 102 of DAC module(s) 100 to which it is operatively attached. In this manner, vertical exhaust plenum 130 acts as a chimney for DAC module 100 to direct clean air 122 exiting outlet side 112 of frame 102 away from frame 102 to reduce re-entry of clean air 122 into inlet side 110 of frame 102. In one non-limiting example, terminal end 136 may be in a range of, for example, 3-4 meters above upper end 138 of frame 102 of DAC module(s) 100. Other dimensions are also possible.

Vertical exhaust plenum 130 may be made of any now known or later developed sheet metal, similar to conventional heat ventilation and air conditioning (HVAC) duct work, but perhaps with heavier scale metal to withstand the environmental and operational conditions experienced by DAC module 100. Side passage(s) 134 of vertical exhaust plenum 130 may be coupled to frame 102 in any known manner, e.g., welding, fasteners, etc. Vertical passage 132 and/or side passage(s) 134 may include any necessary supporting framework, e.g., support struts (not shown), required to position them as desired. Side passage(s) 134 may be positioned at any angle desired to direct clean air 122 into vertical passage(s) 132. Further, as shown in FIG. 7, side passage(s) 134 may include any required air flow diverters 140 to direct clean air 122 where desired.

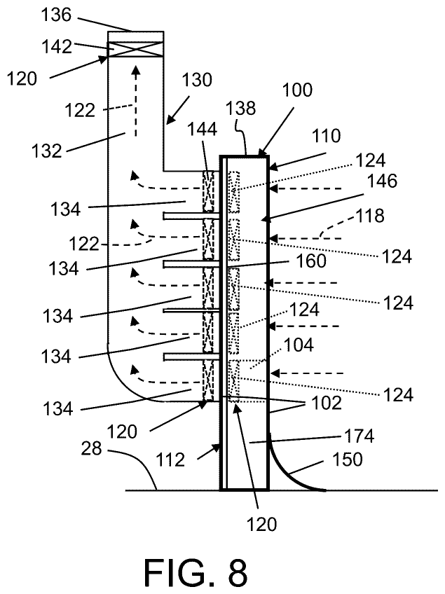

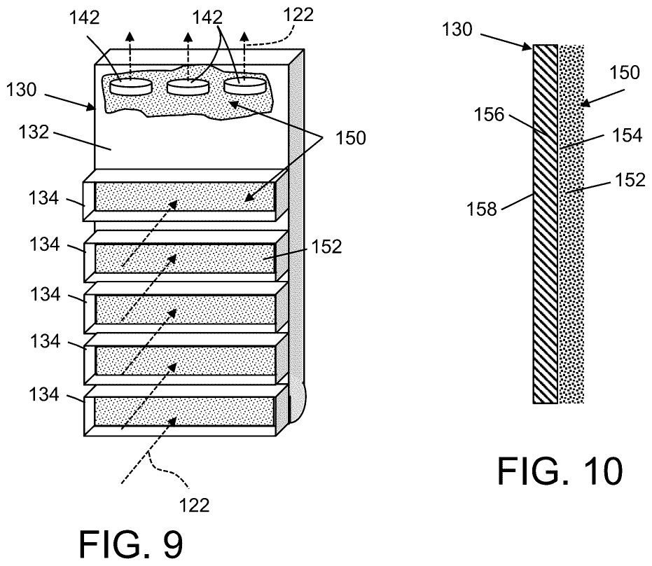

FIG. 8 shows a side view of DAC module 100 according to alternative embodiments. In certain embodiments, air mover(s) 120 may include fan(s) in: frame 102 (i.e., fan(s) 124 as previously described relative to FIG. 4), vertical passage 132 of vertical exhaust plenum 130 (i.e., fan(s) 142 in FIG. 8), and/or side passage(s) 134 of vertical exhaust plenum 130 (i.e., fan(s) 144 in FIG. 8). As noted, FIG. 4 shows an embodiment in which air mover 120 includes only fan(s) 124 within frame 102. With regard to FIG. 8, in certain embodiments, air mover(s) 120 may be positioned in vertical passage 132 of vertical exhaust plenum 130. In this setting, air mover(s) 120 may include one or more fans 142 within vertical passage 132 (see e.g., see-through portion in FIG. 9). With further regard to FIG. 8, in certain embodiments, air mover(s) 120 may be positioned in the side passage(s) 134 of vertical exhaust plenum 130. In this setting, air mover(s) 120 may include one or more fan(s) 144 within side passage(s) 134. Fans 142, 144 may include any now known or later developed industrial fan(s) configured to move a gas stream and may be aimed in any desired manner to direct air flow. As shown in dashed lines in FIG. 8, in certain embodiments, air mover(s) 120 may include fan(s) 142 and/or fan(s) 144, and also include fans 124 within frame 102 (as in FIG. 4). In this arrangement, the at least one level includes a plurality of levels and each respective level includes the plurality of contactors 104 (into/out of page in FIG. 8) and a (first and second) air movers 120 includes fan(s)142 and/or fans(s) 144, and fan(s) 124 configured to draw air into inlet side 110 of the frame at the respective level and over contactors 104 therein. As noted, vertical exhaust plenum 130 includes vertical passage 132 and side passages 134 with each side passage 134 in fluid communication with a respective level at outlet side 112 of frame 102. In this fashion, fan(s) 142 and/or fan(s) 144, and fans 124 can aid in drawing air through DAC module 100. In alternative embodiments, air mover(s) 120 may include only fan(s) 142 in vertical exhaust passage 132, and fan(s) 124 and fan(s) 144 may be omitted. In another embodiment, air mover(s) 120 may include one or more fan(s) 144 in the side passage(s) 134, and fan(s) 142 and/or fan(s) 124 may be omitted. In any event, any necessary air flow volume or rate can be generated by air mover(s) 120.

Vertical exhaust plenum 130, as described herein, can significantly reduce noise of DAC system 200 (FIGS. 13-17). In non-limiting examples, vertical exhaust plenum 130 may reduce noise at stated frequencies as follows:

| | | | | | | | | |
|---|---|---|---|---|---|---|---|---|
| Frequency | 63 | 125 | 250 | 500 | 1000 | 2000 | 4000 | 8000 |
| (Hz) | | | | | | | | |
| Noise without | 103 | 100 | 92 | 89 | 87 | 83 | 78 | 78 |
| plenum (dB) | | | | | | | | |
| Noise with | 102 | 99 | 86 | 57 | 66 | 69 | 54 | 46 |
| plenum (dB) | | | | | | | | |

DAC module 100 may also optionally include a noise-abatement system 170 to further reduce noise. FIG. 9 shows a perspective view of vertical exhaust plenum 130, and FIG. 10 shows a cross-sectional view of a wall of vertical exhaust plenum 130, including a noise-abatement system 170 according to certain embodiments of the disclosure. More particularly, FIG. 9 shows a perspective view of an inlet of vertical exhaust plenum 130 for DAC module 100, and FIG. 10 shows a cross-sectional view of a wall 156 of vertical exhaust plenum 130 including noise-abatement layer 152 thereon. Noise-abatement system 170 may include a noise-abatement layer 152 along at least a portion of interior surface 154 of vertical exhaust plenum 130. Noise-abatement layer 152 may be on any portion(s) of vertical exhaust plenum 130 desired, e.g., within vertical exhaust passage 132 and/or any of side passages 134. Although not shown, noise-abatement layer 152 may also be on any portion of an exterior surface 158 of vertical exhaust plenum 130. Noise-abatement layer 152 may include any now known or later developed material capable of absorbing noise such as but not limited to: porous or auxetic material, metal or metal alloy wool, fiberglass insulation, porous polymer foam and other forms of foam insulation. Noise-abatement layer 152 can have any thickness to obtain the desired noise reduction characteristics. In one non-limiting example, noise-abatement layer 152 may be in a range of 40-60 millimeters thick. Noise-abatement layer 152 may be coupled to vertical exhaust plenum 130 in any now known or later developed fashion such as but not limited to fasteners and adhesive.

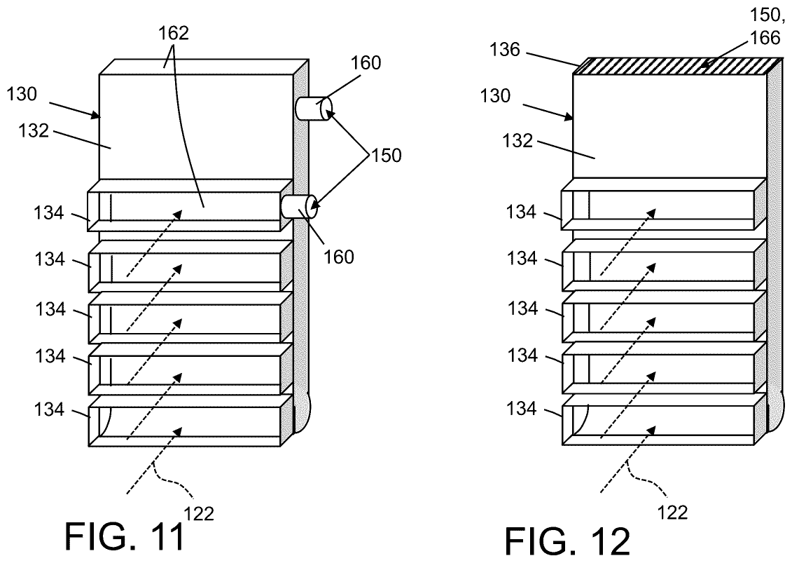

FIG. 11 shows a perspective view of vertical exhaust plenum 130 including noise-abatement system 170 according to other embodiments of the disclosure. In these embodiments, noise-abatement system 170 includes a resonator 160 in fluid communication with an interior 162 of vertical exhaust plenum 130. Resonator 160 may include any now known or later developed resonator structure capable of reducing noise such as but not limited to a Helmholtz resonator or a quarter-wave resonator. While shown on both vertical passage 132 and a side passage 134 of vertical exhaust planum 130, resonator(s) 160 can be at any location desired in fluid communication with interior 162 of vertical exhaust plenum 130. Resonator(s) 160 have been advantageous to further reduce noise, for example, at lower frequencies such as the 62 Hz, 125 Hz and 250 Hz from the table of illustrative frequencies, previously described herein

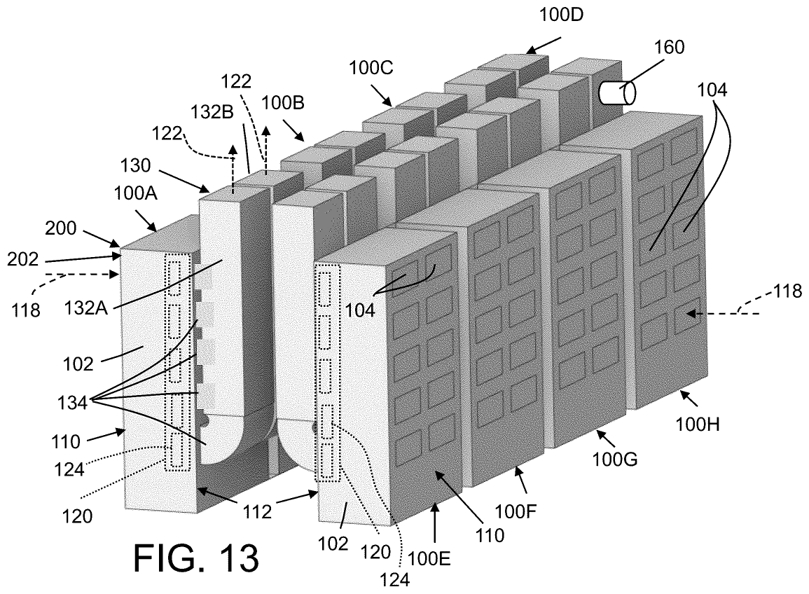

FIG. 12 shows a perspective view of vertical exhaust plenum 130 including noise-abatement system 170 according to yet other embodiments of the disclosure. In these embodiments, noise-abatement system 170 includes a set of louvers 166 at (or near) terminal end 136 of vertical exhaust plenum 130. Set of louvers 166 may include any number of angled slats or flat strips fixed or adjustably positioned at regular intervals in, for example, vertical passage 132. Set of louvers 166 are configured to, among other things, dampen noise. It will be recognized that set of louvers 166 can also control air flow through and/or back-pressure in vertical exhaust plenum 130. While various noise-abatement system 170 variations have been shown separately herein, it is emphasized that they can be combined in any fashion, e.g., noise-abatement layer 152 with set of louvers 166 or resonator(s) 160.

In certain non-limiting examples, where noise-abatement system 170 is used, additional noise reductions of approximately 14 dB across the frequencies stated in the table herein may be possible.

Referring again to FIG. 8, in certain embodiments, DAC module 100 may also include a curved ramp 150 extending from surface 28 upon which frame 102 is supported toward (and along) inlet side 110 of frame 102. Curved ramp 150 directs dirty air 118 flow drawn by air mover(s) 120 along inlet side 110 of frame 102 and prevents debris from surface 28 from entering frame 102 and/or under frame 102. Curved ramp 150 may be used with or without exterior wall 174 (FIGS. 5-8) of frame 102 or may form a part of the exterior wall of frame 102. Curved ramp 150 may have any curvilinear shape configured to mate with surface 28 and inlet side 110 at its ends. Curved ramp 150 may extend vertically up to a lower extent of air mover(s)120 and/or contactors 104 on inlet side 110 of frame 102.

In prior art DAC module 20, as shown in FIG. 1, contactors 24 and fans 26 are raised above surface 28, i.e., the ground or a foundation, within frame 22 by a height H, i.e., contactors 24 and fans 26 are on stilts. The raised arrangement allows air flowing above the ground to avoid entraining dust or other debris and directing it into DAC module 20. However, it has been discovered that the open nature of DAC module 20 allows air to flow upstream and to re-enter the inlet side of DAC module 20, reducing the module's efficiency. In order to address this issue, referring to FIGS. 5-8, DAC module 100 according to embodiments of the disclosure may further include an exterior wall 174 enclosing a lowermost portion 142 of frame 102 and preventing air flow therethrough, i.e., forming a skirting around lowermost portion of frame 102. As shown, exterior wall 174 extends from surface 28 upon which frame 102 is supported such that little to no air passes between surface 28 and a lower end 176 (FIG. 5) of exterior wall 174. Exterior wall 174 may extend vertically up to a lower extent of air mover(s) 120 and/or contactors 104 (see e.g., FIG. 5). Exterior wall 174 may be on inlet side 110 only, or as shown, on inlet side 110 and sides 145, 146 of frame 102. In any case, exterior wall 174 prevents clean air 122 from moving upstream under frame 102 of DAC module 100.

DAC modules 100 can have any size depending on their intended capacity. Contactors 104 and air mover(s) 120 can be sized accordingly. In one non-limiting example, DAC modules 100 can have an overall height in a range of 12 to 25 meters, with each fan 124 in frame 102 or fan 144 in side passage 134 of vertical exhaust plenum 130 and corresponding contactor 104 being approximately 1.5 to 4 meters high. In one non-limiting example, DAC modules 100 can have a depth, i.e., from inlet side 110 to outlet side 112, in a range of approximately 2 to 8 meters, and a width, i.e., from side 145 to side 146, in a range of approximately 10 to 18 meters. As noted, terminal end 136 of vertical exhaust plenum 130 may be, for example, 3-4 meters above upper end 138 of frame 102. Other dimensions may also be possible.

As shown in FIGS. 5-7, DAC module 100 can also optionally include any now known or later developed cleaner system 178. Cleaner system 178 can include any desired pumps (e.g., for water or heat transfer fluid); vacuum pumps (e.g., for evacuation of debris); and/or heaters, condensers and related conduits for cleaning contactors 104. As the process of cleaning DAC modules 100 is known in the art, no further details are required.

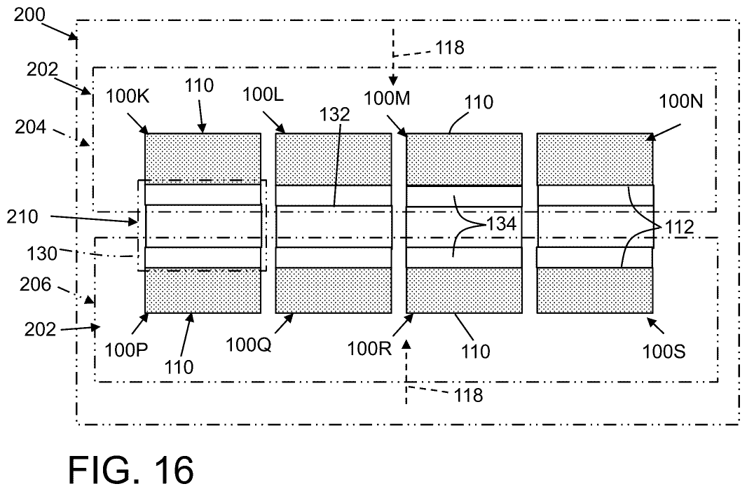

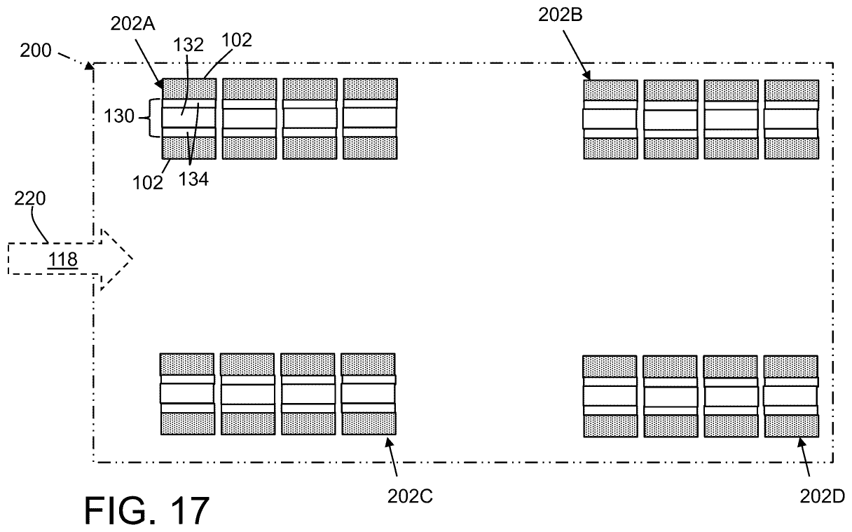

Referring to FIGS. 13-17, a DAC system 200 according to embodiments of the disclosure is shown. DAC system 200 includes at least one set 202 of direct air capture (DAC) modules 100, i.e., a DAC module set. (Note, FIGS. 16-17 show systems 200 or sets 202 within dashed boxes for reference purposes only, the systems are open to the environment—there are no enclosures around systems 200 or sets 202).

FIG. 13 shows an illustrative DAC module set 202 including DAC modules 100 as shown in FIG. 7, i.e., with vertical exhaust plenum 130 including two vertical passages 132A, 132B on each frame 102. Each DAC module set 202 includes at least two DAC modules 100. For example, in FIG. 13, DAC module set 202 includes a first DAC module 100A and a second DAC module 100E adjacent first DAC module 100A. More particularly, FIG. 13 includes four pairs of DAC modules in its set 202: 100A-100E, 100B-100F, 110C-100G and 100D-100H. It is emphasized that while eight DAC modules 100A-H are shown in set 202 in FIG. 13, any number of DAC modules 100 greater than two may be in a DAC module set 202. While DAC modules 100 of the FIG. 7 variety are shown in FIG. 13, any embodiment of DAC module 100 described herein may be used to form a set 202. Further, the different embodiments of DAC module 100 described herein can be mixed and matched within a given set 202. At the least, system 100 includes first DAC module 100A and second DAC module 100E adjacent first DAC module 100A. As noted, each DAC module 100 includes frame 102 including at least one level. Each level includes a plurality of contactors 104.

DAC system 200 in FIG. 13 also includes at least one first air mover 120 (shown as fans 124 inside frame 102, but could be any embodiment described herein) configured to draw air into inlet side 110 of frame 102 and over contactors 104 to remove hazardous gas from dirty air 118, producing cleaned air 122 exiting outlet side 112 of frame 102. DAC modules 100A-H also include, as described herein, vertical exhaust plenum 130 mounted to each of first and second DAC modules 100A-E (also 100B-100F, 100C-100G and 100D-100H). Each vertical exhaust plenum 130 is in fluid communication with outlet side 112 of frame 102 of a respective one of first and second DAC modules, e.g., 100A-100E, and configured to direct clean air 122 exiting outlet sides 112 of frames 102 away from frames 102 to reduce re-entry of the clean air into inlet sides 110 of frames 102—see arrows for clean air 122. As described herein, each vertical exhaust plenum 130 includes vertical passage 132 (two 132A, 132B shown for each frame 102 in FIG. 13) and side passage 134 in fluid communication with each respective level at outlet side 112 of frames 102 of the respective one of first and second DAC modules, e.g., 100A-100E. As shown in FIGS. 9-12, at least one of vertical exhaust plenums 130 in DAC modules 100A-100H may optionally include noise-abatement system 170 including at least one of: noise-abatement layer 152 (FIGS. 9-10) along at least a portion of interior surface 154 (FIG. 10) of vertical exhaust plenum 130, resonator 160 (FIG. 11) in fluid communication with an interior of vertical exhaust plenum 130, and a set of louvers 166 (FIG. 12) at terminal end 136 of vertical exhaust plenum 130. At least one vertical exhaust plenum 130 in DAC modules 100A-H in set 202 in FIG. 13 may also include second air mover(s) 120 having a flow direction away from inlet side(s) 110 of frame 102 to reduce re-entry of clean air 122 into inlet side(s) 110 of frame(s) 102. For example, vertical exhaust plenum(s) 130 in DAC module(s) 100A-H in set 202 in FIG. 13 may also include second air mover(s) 120 in the form of, as shown in FIG. 8, fan(s) 144 in the side passage(s) 134 and/or fan(s) 142 in vertical passage 132. Any arrangement of air mover(s) 120 as described herein can be used in any variety of DAC module sets 202, described herein.

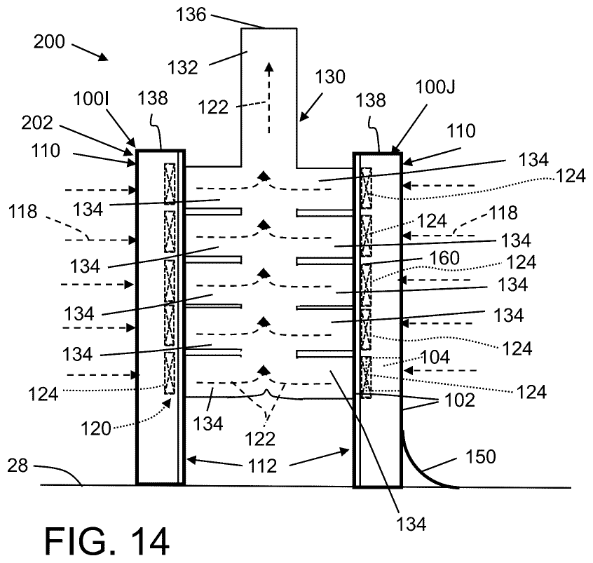

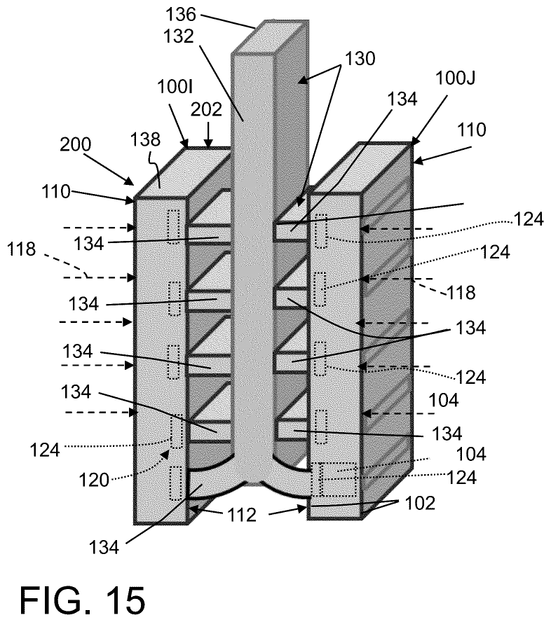

FIG. 14 shows a side view and FIG. 15 shows a perspective view of a DAC module system 200 according to other embodiments of the disclosure. DAC module system 200 in FIGS. 14-15 is similar to that of FIG. 13, except DAC modules 100I, 100J share vertical passage 132 of vertical exhaust passage 130. That is, each DAC module 100I, 100J has its own side passage(s) 134 that feed into a single, shared vertical passage 134 between frames 102. As noted, each DAC module set 202 includes at least two DAC modules 100, e.g., 100I, 100J. In FIGS. 14-15, DAC module set 202 includes, for example, a first DAC module 100I and a second DAC module 100J adjacent first DAC module 100I. While FIGS. 14-15 only show one pair of DAC modules in its set 202, it is understood the pairs of DAC modules 100I, 100J can be repeated as in FIG. 13. Any number of DAC modules 100 greater than two may be in a DAC module set 202. At the least, system 100 includes first DAC module 100I and second DAC module 100J adjacent first DAC module 100I. As noted, each DAC module 100 includes frame 102 including at least one level. Each level includes a plurality of contactors 104 and an outlet side 112.

DAC system 200 in FIGS. 14-15 also includes at least one first air mover 120 (shown as fans 124 inside frame 102 but could be any embodiment described herein) configured to draw air into inlet side 110 of frame 102 and over contactors 104 to remove hazardous gas from dirty air 118, producing cleaned air 122 exiting outlet side 112 of frame 102. DAC modules 100I-J also include vertical exhaust plenum 130 mounted between first and second DAC modules 100I, 110J. Vertical exhaust plenum 130 is in fluid communication with outlet side 112 of frames 102 of first and second DAC modules 100I, 100J and is configured to direct clean air 122 exiting outlet sides 112 of frames 102 away from frames 102 to reduce re-entry of clean air 122 into inlet sides 110 of frames 102. Vertical exhaust plenum 130 includes vertical passage 132 and side passage(s) 134 in fluid communication with outlet sides 112 of frames 102 of first and second DAC modules 100I, 100J. More particularly, vertical exhaust plenum 130 includes a single (shared) vertical passage 132 in fluid communication with side passage(s) 134 (left side) in fluid communication with outlet side 112 of frame 102 of first DAC modules 100I and side passage(s) 134 (right side) in fluid communication with outlet side 112 of frame of second DAC module 100J. The single, shared vertical passage 132 reduces the space required between DAC modules 100, and thus the space required for a DAC module set 202 and DAC system 200.

As shown in FIGS. 9-12, vertical exhaust plenum 130 in DAC modules 100I-J may optionally include noise-abatement system 170 including at least one of: noise-abatement layer 152 (FIGS. 9-10) along at least a portion of interior surface 154 (FIG. 10) of vertical exhaust plenum 130, resonator 160 (FIG. 11) in fluid communication with an interior of vertical exhaust plenum 130, and a set of louvers 166 (FIG. 12) at terminal end 136 of vertical exhaust plenum 130. At least one vertical exhaust plenum 130 in DAC modules 100I-J in set 202 in FIGS. 14-15 may also include second air mover(s) 120 having a flow direction away from frame 102 thereof to reduce re-entry of clean air 122 into inlet side(s) 110 of frame(s) 102. For example, vertical exhaust plenum(s) 130 in DAC modules 100I, J in set 202 in FIGS. 14-15 may also include second air mover(s) 120 in the form of, as shown in FIG. 8, fan(s) 144 in the side passage(s) 134 and/or fan(s) 142 in single, shared vertical passage 132. Any arrangement of air mover(s) 120 as described herein can be used in any variety of DAC module sets 202, described herein. Also, the different embodiments of DAC module 100 described herein can be mixed and matched within a given set 202.

As shown in FIG. 16, each set 202 in a DAC system 200 may include a first plurality 204 of DAC modules 100K-N (100“O” omitted for clarity) arranged in a first line, and a second plurality 206 of DAC modules 100P-S arranged in a second line. The first line of DAC modules 100K-N is parallel to the second line of DAC modules 100P-S, so as to form a space 210 between facing outlet sides 112 in which vertical exhaust plenum 130 is positioned.

FIG. 17 shows a DAC system 200 including at least two sets 202. Each set 202 can be of any variety described herein. In the FIG. 17 example, the DAC module set 202 has the arrangement of FIGS. 14-15. As also shown in FIG. 17, the at least two sets 202 may be arranged in parallel lines, i.e., lengthwise. In FIG. 17, four sets 202A-D are shown with set 202A parallel to set 202C and set 202B parallel to set 202D. It is emphasized that while four sets 202A-D are shown, any number of sets 202 can be used in a given DAC system 200. In certain embodiments, the at least two sets 202A, C and 202B, D arranged in parallel are also arranged to be substantially parallel to a predominate wind direction 220 in a location of the at least two sets 202A, C; 202B, D. In the example shown, predominate wind direction 220 is left-to-right on the page of FIG. 17. In certain embodiments, “substantially parallel” may mean+/−30°; in another embodiment, “substantially parallel” may mean+/−20°; in another embodiment, “substantially parallel” may mean+/−10°; and in another embodiment, “substantially parallel” may mean+/−5°. It has been discovered that when DAC modules 100, including the structures described herein and arranged as described herein, and with the predominate wind direction 220 substantially parallel to sets 202, the system advantageously results in increased circulation without increasing re-entry of clean air 122 to inlet sides 110 of DAC modules 100. System 200 also reduces the vortex effect on clean air 122 and reduces the pressure differences across DAC modules 100. In certain embodiments, this arrangement may result in less than 10% of incoming air, i.e., dirty air 118, entering DAC modules 100 to recirculate to the DAC modules. In additional embodiments, this arrangement may result in less than 4% of incoming air, i.e., dirty air 118, entering DAC modules 100 to recirculate to the DAC modules. Use of vertical exhaust plenum 130 as described herein also allow DAC modules 100 to be placed closer together compared to previous configurations, which typically has at least 50 meters between sets 202A-D in both the vertical and horizontal directions on the page of FIG. 17. For example, in certain embodiments, a distance between sets 202A-D in the vertical and horizontal directions on the page of FIG. 17 can be as low as 10 meters.

Embodiments of the disclosure provide various technical and commercial advantages, examples of which are discussed herein. For example, DAC systems according to embodiments of the disclosure can capture, for example, 1 million tons of carbon dioxide from the atmosphere while maintaining a maximum of 10% (and possibly less than 4%) recirculation value. In another example, fewer DAC modules 100 are necessary, resulting in a smaller overall footprint and a less costly DAC system 200.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of the technology and to enable others of ordinary skill in the art to understand the disclosure for contemplating various modifications to the present embodiments, which may be suited to the particular use contemplated.

What is claimed is:

1. A direct air capture (DAC) module, comprising:
a frame enclosing at least one level, each level including a plurality of hazardous gas capture contactors;
a first air mover configured to draw air into an inlet side of the frame and over the plurality of hazardous gas capture contactors to remove hazardous gas from the air, producing cleaned air from an outlet side of the frame; and
a vertical exhaust plenum fluidly coupled to the outlet side of the frame, the vertical exhaust plenum in fluid communication with the outlet side of the frame and configured to direct the clean air exiting the outlet side of the frame away from the frame to reduce re-entry of the clean air into the inlet side of the frame.

2. The DAC module of claim 1, wherein the vertical exhaust plenum further includes a vertical passage and at least one side passage in fluid communication with the outlet side of the frame and the vertical passage.

3. The DAC module of claim 2, wherein the first air mover is positioned in the vertical passage of the vertical exhaust plenum.

4. The DAC module of claim 3, wherein the at least one level includes a plurality of levels, each respective level including the plurality of hazardous gas capture contactors and a second air mover configured to draw air into the inlet side of the frame at the respective level and over the plurality of hazardous gas capture contactors therein, and wherein the vertical exhaust plenum includes a vertical passage and a plurality of side passages, each side passage in fluid communication with a respective level at the outlet side of the frame.

5. The DAC module of claim 2, wherein the at least one level includes a plurality of levels, each respective level including the plurality of hazardous gas capture contactors and a respective first air mover configured to draw air into the inlet side of the frame at the respective level and over the plurality of hazardous gas capture contactors therein, and wherein the vertical exhaust plenum includes a plurality of side passages, each side passage in fluid communication with of a respective level at the outlet side of the frame.

6. The DAC module of claim 1, wherein the vertical exhaust plenum includes a noise-abatement system.

7. The DAC module of claim 6, wherein the noise-abate system includes a noise-abatement layer along at least a portion of an interior surface of the vertical exhaust plenum.

8. The DAC module of claim 6, wherein the noise-abate system includes a resonator in fluid communication with an interior of the vertical exhaust plenum.

9. The DAC module of claim 6, wherein the noise-abate system includes a set of louvers at a terminal end of the vertical exhaust plenum.

10. A direct air capture (DAC) system, comprising:
at least one DAC module set, each DAC module set including:
a first direct air capture (DAC) module;
a second DAC module adjacent the first DAC module, wherein each DAC module includes a frame including at least one level, each level including a plurality of hazardous gas capture contactors;
at least one first air mover configured to draw air into an inlet side of the frame and over the plurality of hazardous gas capture contactors to remove hazardous gas from the air, producing cleaned air exiting an outlet side of the frame; and
a vertical exhaust plenum mounted to each of the first and second DAC modules, each vertical exhaust plenum in fluid communication with the outlet side of the frame of a respective one of the first and second DAC modules and configured to direct the clean air exiting the outlet sides of the frames away from the frames to reduce re-entry of the clean air into the inlet sides of the frames.

11. The DAC system of claim 10, wherein each vertical exhaust plenum includes a vertical passage and a side passage in fluid communication with each respective level at the outlet side of the frames of the respective one of the first and second DAC modules.

12. The DAC system of claim 10, wherein at least one of the vertical exhaust plenums includes a noise-abatement system including at least one of: a noise-abatement layer along at least a portion of an interior surface of the vertical exhaust plenum, a resonator in fluid communication with an interior of the vertical exhaust plenum, and a set of louvers at a terminal end of the vertical exhaust plenum.

13. The DAC system of claim 10, wherein the at least one DAC module set includes at least two DAC module sets arranged in parallel to be substantially parallel to a predominate wind direction in a location of the at least two DAC module sets.

14. The DAC system of claim 10, wherein at least one of the vertical exhaust plenums includes at least one second air mover having a flow direction away from the frame to reduce re-entry of the clean air into the inlet side of the frame.

15. The DAC system of claim 10, wherein each vertical exhaust plenum has a terminal end vertically above an upper end of the frame of the respective one of the first and second DAC modules.

16. A direct air capture (DAC) system, comprising:
at least one DAC module set, each DAC module set including:
a first direct air capture (DAC) module;
a second DAC module adjacent the first DAC module,
wherein each DAC module includes a frame including at least one level, each level including an inlet side, a plurality of hazardous gas capture contactors and an outlet side;
at least one first air mover configured to draw air into the inlet side of the frame and over the plurality of hazardous gas capture contactors to remove hazardous gas from the air, producing cleaned air exiting the outlet side of the frame; and
a vertical exhaust plenum mounted between the first and second DAC modules, the vertical exhaust plenum in fluid communication with the outlet side of the frames of the first and second DAC modules and configured to direct the clean air exiting the outlet sides of the frames away from the frames to reduce re-entry of the clean air into the inlet sides of the frames, wherein the vertical exhaust plenum includes a vertical passage and a side passage in fluid communication with the outlet sides of the frames of the first and second DAC modules.

17. The DAC system of claim 16, wherein the at least one first air mover is positioned in the vertical passage of the vertical exhaust plenum.

18. The DAC system of claim 17, wherein the vertical exhaust plenum includes a single vertical passage in fluid communication with a side passage in fluid communication with the outlet side of the first DAC module and a side passage in fluid communication with the outlet side of the second DAC module.

19. The DAC system of claim 16, wherein the vertical exhaust plenum includes a noise-abatement system including at least one of: a noise-abatement layer along at least a portion of an interior surface of the vertical exhaust plenum, a resonator in fluid communication with an interior of the vertical exhaust plenum, and a set of louvers at a terminal end of the vertical exhaust plenum.

20. The DAC system of claim 16, wherein the vertical exhaust plenum has a terminal end vertically above an upper end of each of the frame of the first and second DAC modules.
